(19) United States
(12) Patent Application Publication
(10) Pub. No.: US 2017/0369814 A1
(43) Pub. Date: Dec. 28, 2017

(54) LUBRICATING COMPOSITION COMPRISING A PHASE-CHANGE MATERIAL

(71) Applicant: TOTAL MARKETING SERVICES, Puteaux (FR)

(72) Inventor: Nicolas OBRECHT, Meistratzheim (FR)

(21) Appl. No.: 15/538,947

(22) PCT Filed: Dec. 22, 2015
(86) PCT No.: PCT/EP2015/080908

§ 371 Date: Jun. 22, 2017

(30) Foreign Application Priority Data
Dec. 23, 2014 (FR) 1463188

(51) Int. Cl. C10M 169/04; C11D 1/722; C10M 125/14; C10M 145/14; C10M 145/22

(52) U.S. Cl. CPC C10M 169/041; C10M 145/14; C10M 145/22; C10M 125/14; C11D 1/722; C10M 2201/02; C10M 2203/1025; C10N 2230/08; C10N 2230/10; C10N 2240/103; C10N 2230/04

(57) ABSTRACT

Disclosed is a lubricating composition including a base oil, a surfactant system and a phase-change material, especially water. The lubricating composition according to the invention is used to lubricate engines, especially for a vehicle. It has improved thermal performances compared to lubricating compositions of prior art. It also reduces clogging of the engine parts.

The invention concerns the field of lubricants and provides a lubricating composition comprising a base oil, a surfactant system and a phase-change material, especially water. The lubricating composition of the invention is used to lubricate a vehicle engine. It has improved thermal performance compared with prior art lubricating compositions. It also provides a reduction in the clogging of engine parts.

Developments in engines and the performance of engine lubricating compositions are inextricably linked. The more engine design becomes complex, the higher the yield and optimisation of consumption, and the greater the demand placed on engine lubricating compositions for which performance must be improved.

Very high compression inside engines, higher piston temperatures in particular in the segment portion of the upper piston, modern maintenance-free valve controls with hydraulic plungers, and very high temperatures in the engine space constantly place increasing demand on lubricants for modern engines.

The conditions of use of petrol engines and diesel engines include both extremely short trips and long distances. The journeys travelled by 80% of motor vehicles in Western Europe cover less than 12 kilometres, whereas vehicles clock up annual mileages of up to 300 000 km.

Oil change intervals are also most variable, being 5 000 km for some small diesel engines and may extend to 100 000 km for diesel engines of modern commercial vehicles.

Lubricating compositions, and in particular lubricating compositions for motor vehicle engines, must therefore have improved properties and performance levels.

One problem encountered when using known lubricating compositions concerns the degradation and coking of the oils or additives used. These degradation and coking phenomena may lead to clogging of the lubricated parts, in particular inside a vehicle engine.

One problem encountered when using known lubricating compositions concerns the degradation and coking of the oils or additives used. These degradation and coking phenomena may lead to clogging of the lubricated parts, in particular inside a vehicle engine.

It is therefore necessary to provide lubricating compositions allowing an improvement in engine cleanliness. The improvement of engine cleanliness generally comprises reduced formation of deposits, in particular the formation of deposits at high temperatures such as varnish, paint, carbon or coke deposits. Such deposits may form on hot surfaces of engine parts such as the bottom of piston grooves or on turbocharger shafts. The substances contained in lubricating compositions may oxidize in contact with hot engine surfaces and generate the formation of insoluble products forming deposits. These deposits may foul the engine and cause problems of wear, seizure, sticking of segments and problems related to turbocharger rotation for example. In general, additives of detergent type of used to improve engine cleanliness.

Lubricating compositions are therefore needed with which it is possible efficiently to combat these phenomena, and in particular lubricating compositions need to be provided having improved heat resistance properties.

It is also necessary to provide lubricating compositions which can lower the temperature of the epilamen (film or skin of a lubricating composition) on lubricated mechanical parts of an engine and in particular on the pistons. To have available lubricating compositions which can lower the temperature of contacting parts e.g. inside a motor vehicle engine would therefore be particularly advantageous.

Lubricating compositions allowing absorption of part of the heat produced by an engine in operation are therefore needed.

It has now been found that the use of a phase-change material in combination with an oil and a surfactant system can allow absorption of part of the heat produced during lubrication, in particular inside a working engine, and thereby allow lowering of the temperature to which the oil and additives used are subjected.

In addition, the stability of lubricating compositions must also be ensured, in particular when used to lubricate an engine. Apart from the heat inside an engine, lubricating compositions undergo major mechanical stresses, shear stresses in particular.

For lack of being sufficiently stable, oils and additives of lubricating compositions may separate or degrade and lose all or part of their properties. In particular, lubricating compositions comprising different phases e.g. emulsions may be degraded and lead to separation of the oils and additives. When such separation occurs, particularly of emulsions contained in lubricating compositions, some elements or additives may deposit on the lower parts of the engine for example. Lubricating compositions thus degraded may lose their properties and lead to accelerated degradation of oils and additives, resulting in increased fouling of engine parts.

There is therefore a need for engine lubricating compositions which have improved performance levels and particularly allow the limiting or avoiding of coking and clogging problems.

The invention therefore provides a lubricating composition which brings a solution to all or part of the problems of prior art lubricating compositions.

The present invention concerns the use of a monophasic lubricating composition comprising:
a base oil,
a surfactant system comprising:
   at least one non-ionic surfactant derivative of fatty alcohols, or
   a mixture of at least two non-ionic surfactant derivatives of fatty alcohols, or
   a condensate of at least two non-ionic surfactant derivatives of fatty alcohols, or
   any combination thereof,
up to 5% by weight of a phase-change material.

The composition is monophasic, translating in the composition as a low content of phase-change material, water in particular, that is no more than 5% by weight. It therefore comprises a single phase and differs from an emulsion. The monophasic lubricating composition of the invention can therefore undergo mechanical stresses, shear stresses in particular, without the risk of undergoing separation of the oil, of the surfactant material and of the phase-change material.

Preferably, the lubricating composition of the invention comprises a surfactant system comprising at least one derivative of polyalkoxylated fatty alcohols comprising a saturated or unsaturated, straight-chain or branched C₁₂-C₆₀-alkyl group.

Also preferably, the lubricating composition of the invention comprises a surfactant system comprising at least one derivative selected from among:
derivatives of polyalkoxylated fatty alcohols, particularly polyethoxylated, comprising a saturated or unsaturated, straight-chain or branched C₁₂-C₆₀-alkyl group e.g. derivatives of polyalkoxylated, particularly polyethoxylated, fatty alcohols comprising a saturated, straight-chain or branched C₁₆-C₆₀-alkyl group e.g. derivatives of polyalkoxylated, particularly polyethoxylated, fatty alcohols comprising an unsaturated, straight-chain or branched C₁₆-C₆₀-alkyl group;
a fatty alcohol alkoxylate, in particular a fatty alcohol ethoxylate, particularly a C₁₂-C₃₀ fatty alcohol ethoxylate, particularly a C₁₆-C₂₄ fatty alcohol ethoxylate, preferably a C₈-C₂₄ fatty alcohol ethoxylate;
a fatty alcohol polyglycol ether;
a C₁₆-C₁₈ oleic alcohol derivative;
a C₁₆-C₁₈ oleic alcohol derivative comprising saturated C₁₆-C₁₈ groups, unsaturated C₁₈ groups and alkoxy groups, particularly ethoxy groups;
a C₁₆-C₁₈ oleic alcohol derivative comprising saturated C₁₆-C₁₈ groups, unsaturated C₁₈ groups and 2 to 5 alkoxy groups, particularly ethoxy groups.

Advantageously, the lubricating composition of the invention comprises a surfactant system comprising a mixture of at least two non-ionic surfactant derivatives of fatty alcohols. The non-ionic surfactant derivatives of fatty alcohols can then be selected from among derivatives of polyalkoxylated fatty alcohols comprising a saturated or unsaturated, straight-chain or branched C₁₂-C₆₀-alkyl group. They may also be selected from among:
derivatives of polyalkoxylated, particularly polyethoxylated, fatty alcohols comprising a saturated or unsaturated, straight-chain or branched C₁₂-C₆₀-alkyl group e.g. derivatives of polyalkoxylated fatty alcohols, particularly polyethoxylated, comprising a saturated, straight-chain or branched C₁₆-C₆₀-alkyl group e.g. derivatives of polyalkoxylated fatty alcohols, particularly polyethoxylated, comprising an unsaturated straight-chain or branched C₁₆-C₆₀-alkyl group.
a fatty alcohol alkoxylate, particularly a fatty alcohol ethoxylate, in particular a C₁₂-C₃₀ fatty alcohol ethoxylate, particularly a C₁₆-C₂₄ fatty alcohol ethoxylate, preferably a C₁₈-C₂₄ fatty alcohol ethoxylate;
fatty alcohol polyglycol ether;
a C₁₆-C₁₈ oleic alcohol derivative;
a C₁₆-C₁₈ oleic alcohol derivative comprising saturated C₁₆-C₁₈ groups, unsaturated C₁₈ groups and alkoxy groups, in particular ethoxy groups;
a C₁₆-C₁₈ oleic alcohol derivative comprising saturated C₁₆-C₁₈ groups, unsaturated C₁₈ groups and 2 to 5 alkoxy groups, in particular ethoxy groups.

Preferably, the lubricating composition of the invention comprises a surfactant system comprising a mixture of:
(a) a fatty alcohol alkoxylate, in particular a fatty alcohol ethoxylate, particularly a C₁₂-C₃₀ fatty alcohol ethoxylate, particularly a C₁₆-C₂₄ fatty alcohol ethoxylate, preferably a C₁₈-C₂₄ fatty alcohol ethoxylate; and
(b) a C₁₆-C₁₈ oleic alcohol derivative comprising saturated C₁₆-C₁₈ groups, unsaturated C₁₈ groups and 2 to 5 alkoxy groups, ethoxy groups in particular.

In addition to a base oil and a particular surfactant system, the lubricating composition of the invention comprises a phase-change material. Preferably the phase-change material is a material with liquid-gas phase change.

Also preferably, the phase-change material has an enthalpy of vaporization or latent heat of vaporization, measured at 100° C. and under 0.101 MPa, ranging from 800 to 3 500 kJ/kg, preferably 1 000 to 2 500 kJ/kg.

One preferred example of phase-change material has an enthalpy of vaporization of 2257 kJ/kg, measured at 100° C. and under 0.101 MPa.

Also preferably, the phase-change material has a boiling point at normal pressure ranging from 50 to 150° C., preferably 90 to 120° C.

According to the invention, as examples of phase-change material, preference is given to a material selected from among water, carboxylic acids, ethers, alcohols, in particular short-chain alcohols and particularly C₁-C₈ alcohols. According to the invention the preferred phase-change material is water.

Advantageously, the lubricating composition of the invention may comprise up to 1.7%, up to 1.8%, up to 2% or up to 3% by weight of phase-change material.

Proportions of phase-change material in the lubricating composition of the invention may be 0.1 to 5%, 0.1 to 3%, 0.1 to 2%, 0.1 to 1.8%, 0.1 to 1.7%, 0.1 to 1.5%, 0.1 to 1.2% or 0.1 to 1% by weight of phase-change material in the lubricating composition. They may also be 0.2 to 5%, 0.2 to 3%, 0.2 to 2%, 0.2 to 1.8%, 0.2 to 1.7%, 0.2 to 1.5%, 0.2 to 1.2% or 0.2 to 1% by weight of phase-change material in the lubricating composition. Or even 0.5 to 5%, 0.5 to 3%, 0.5 to 2%, 0.5 to 1.8%, 0.5 to 1.7%, 0.5 to 1.5%, 0.5 to 1.2% or 0.5 to 1% by weight of phase-change material in the lubricating composition.

Preferably, the lubricating composition of the invention may therefore comprise up to 5% by weight of water. It may also comprise up to 1.7%, up to 1.8%, up to 2% or up to 3% by weight of water in the lubricating composition. Proportions of water in the lubricating composition of the invention may be 0.1 to 5%, 0.1 to 3%, 0.1 to 2%, 0.1 to 1.8%, 0.1 to 1.7%, 0.1 to 1.5%, 0.1 to 1.2% or 0.1 to 1% by weight of water in the lubricating composition. They may also be 0.2 to 5%, 0.2 to 3%, 0.2 to 2%, 0.2 to 1.8%, 0.2 to 1.7%, 0.2 to 1.5%, 0.2 to 1.2% or 0.2 to 1% by weight of water in the lubricating composition. Or even 0.5 to 5%, 0.5 to 3%, 0.5 to 2%, 0.5 to 1.8%, 0.5 to 1.7%, 0.5 to 1.5%, 0.5 to 1.2% or 0.5 to 1% by weight of water in the lubricating composition.

Also advantageously, the lubricating composition of the invention may comprise 1 to 30% by weight of a mixture of phase-change material and surfactant system relative to total lubricating composition weight. Preferably, the lubricating composition of the invention may comprise 2 to 20% by weight of a mixture of phase-change material and surfactant system relative to total lubricating composition weight. More preferably, the lubricating composition of the invention may comprise 5 to 15% by weight of a mixture of phase-change material and surfactant system relative to total lubricating composition weight.

The lubricating composition of the invention comprises a particular surfactant system and a phase-change material. It also comprises a base oil.

In general, the lubricating composition of the invention may comprise any type of mineral, synthetic or natural, animal or vegetable lubricating base oil suitable for use thereof. The base oils used in the lubricating compositions of the invention may therefore be oils of mineral or synthetic origin belonging to groups I of V of the API classification (or the equivalents thereof in the ATIEL classification) (Table A) or mixtures thereof.

TABLE A

| | Saturates | Sulfur | Viscosity |
|---|---|---|---|
| | content | content | index (VI) |
| Group I | <90% | >0.03% | 80 ≦ VI < 120 |
| Mineral oils | | | |
| Group II | ≧90% | ≦0.03% | 80 ≦ VI < 120 |
| Hydrocracked oils | | | |
| Groupe III | ≧90% | ≦0.03% | ≧120 |
| Hydrocracked or | | | |
| hydro-isomerized | | | |
| oils | | | |

| | |
|---|---|
| Group IV | Polyalphaolefins (PAOs) |
| Group V | Esters and other bases not |
| | included in Groups 1 to IV |

The mineral base oils that can be used for the lubricating composition of the invention include all types of bases obtained by atmospheric and vacuum distillation of crude oil, followed by refining operations such as solvent extraction, deasphalting, solvent de-waxing, hydrotreatment, hydrocracking, hydroisomerization and hydrofinishing. Mixtures of synthetic and mineral oils can also be employed.

In general, there is no limit as to the use of different lubricating bases to produce the lubricating compositions of the invention, other than that they must have properties particularly of viscosity, viscosity index, sulfur content and oxidation resistance that are adapted for use in engines or for vehicle transmission parts.

The base oils of the lubricating compositions of the invention may also be selected from among synthetic oils such as some esters of carboxylic acids and alcohols, and from among polyalphaolefins. The polyalphaolefins used as base oils are obtained for example from monomers having 4 to 32 carbon atoms, e.g. from octene or decene and having a viscosity at 100° C. of between 1.5 and 15 mm²·s⁻¹ as per the ASTM D445 standard. Their molecular weight average is generally between 250 and 3 000 as per the ASTM D5296 standard.

Advantageously, according to the invention, the base oil can be selected from among the oils of Group III, the oils of Group IV and the oils of Group V.

The lubricating composition of the invention may also comprise another base oil. This other base oil can be selected from among the oils of Group III, the oils of Group IV and the oils of Group V.

Advantageously, the lubricating composition of the invention comprises at least 50% by weight of base oil relative to the total weight of the composition. More advantageously, the lubricating composition of the invention comprises at least 60% by weight, even at least 70% by weight of base oil relative to the total weight of the composition. Further advantageously, the lubricating composition of the invention comprises 50, 60 or 70 to 99.9% by weight, or 50, 60 or 70 to 90% by weight of one or more base oils relative to the total weight of the composition.

The lubricating composition of the invention may also comprise at least one additive. Numerous additives can be used for the lubricating composition of the invention. The preferred additives for the lubricating composition of the invention are selected from among detergent additives, anti-wear additives, friction modifying additives, extreme-pressure additives, dispersants, pour point improvers, defoaming additives, thickeners and mixtures thereof. Preferably, the lubricating composition of the invention comprises at least one anti-wear additive, at least one extreme-pressure additive or mixtures thereof. Anti-wear additives and extreme-pressure additives protect friction surfaces through the formation of a protective film adsorbed on these surfaces.

There exists a wide variety of anti-wear additives. Preferably, for the lubricating composition of the invention, the anti-wear additives are selected from among phospho-sulfurized additives such as metal alkylthiophosphates, in particular zinc alkylthiophosphates, and more specifically zinc dialkyldithiophosphates or ZnDTPs. The preferred compounds have the formula Zn((SP(S)(OR¹)(OR²))₂, where R¹ and R², the same or different, are each independently an alkyl group, preferably an alkyl group having 1 to 18 carbon atoms.

Amine phosphates are also anti-wear additives that can be used in the lubricating composition of the invention. However, the phosphorus contributed by these additives may act as poison for catalytic systems of motor vehicles since these additives generate ash. These effects can be minimised by partly substituting amine phosphates by additives that do not contain phosphorus such as polysulfides for example in particular sulfurized olefins.

Advantageously the lubricating composition of the invention may comprise 0.01 to 6% by weight, preferably 0.05 to 4% by weight, more preferably 0.1 to 2% by weight of anti-wear additives and extreme-pressure additives relative to the total weight of the lubricating composition.

Advantageously, the lubricating composition of the invention may comprise at least one friction modifying additive. The friction modifying additive can be selected from among a compound providing metal elements and an ash-free compound. Among the compounds providing metal elements, mention can be made of transition metal complexes such as Mo, Sb, Sn, Fe, Cu, Zn, the ligands of which may be hydrocarbon compounds comprising atoms of oxygen, nitrogen, sulfur or phosphorus. The ash-free friction modifying additives are generally or organic origin and can be selected from among the monoesters of fatty acids and polyols, alkoxylated amines, alkoxylated fatty amines, fatty epoxides, borate fatty epoxides; fatty amines or fatty acid glycerol esters. According to the invention the fatty compounds comprise at least one hydrocarbon group having 10 to 24 carbon atoms.

Advantageously, the lubricating composition of the invention may comprise 0.01 to 2% by weight, or 0.01 to 5% by weight, preferably 0.1 to 1.5% by weight or 0.1 to 2% by weight of friction modifying additive relative to the total weight of the lubricating composition.

Advantageously, the lubricating composition of the invention may comprise at least one antioxidant additive. An antioxidant additive generally allows delayed degradation of the lubricating composition in use. This degradation may notably translate as the formation of deposits, as the presence of sludge or as an increase in viscosity of the lubricating composition.

Antioxidant additives particularly act as radical inhibitors or hydroperoxide decomposers. Among the antioxidant additives frequently employed, mention can be made of antioxidant additives of phenolic type, antioxidant additives of amino type, phosphor-sulfurized antioxidant additives. Some of these antioxidant additives e.g. phospho-sulfurized antioxidant additives may generate ash. Phenolic antioxidant additives may be ash-free or may be in the form of neutral or basic metal salts. Antioxidant additives can be selected in particular from among sterically hindered phenols, sterically hindered phenol esters and sterically hindered phenols comprising a thioether bridge, diphenylamines, diphenylamines substituted by at least one C₁-C₁₂ alkyl group N,N′-dialkyl-aryl-diamines, and mixtures thereof.

Preferably, according to the invention, the sterically hindered phenols are selected from among compounds comprising a phenol group wherein at least one vicinal carbon of the carbon carrying the alcohol function is substituted by at least one C₁-C₁₀ alkyl group, preferably a C₁-C₆ alkyl group, preferably a C₄ alkyl group, preferably by the tert-butyl group.

Amino compounds are another class of antioxidant additives that can be used, optionally in combination with phenolic antioxidant additives. Examples of amino compounds are the aromatic amines e.g. the aromatic amines of formula NR^{a}R^{b}R^{c} where R^{a} is an aliphatic group or aromatic group, optionally substituted, R^{b} is an aromatic group, optionally substituted, R^{c} is a hydrogen atom, an alkyl group, an aryl group or a group of formula R^{d}S(O)_{z}R^{e} where R^{d} is an alkylene group or alkenylene group, R^{e} is an alkyl group, an alkenyl group or aryl group and z is 0, 1 or 2.

Sulfurized alkyl phenols or the alkaline or alkaline-earth metal salts thereof can also be used as antioxidant additives.

Another class of antioxidant additives is that of copper compounds e.g. copper thio- or dithio-phosphates, copper and carboxylic acid salts, copper dithiocarbamates, sulfonates, phenates and acetylacetonates. Copper I and II salts, the salts of succinic acid or anhydride can also be used.

The lubricating composition of the invention may contain any type of antioxidant additives known to persons skilled in the art.

Advantageously, the lubricating composition comprises at least one ash-free antioxidant additive.

Also advantageously, the lubricating composition of the invention comprises 0.5 to 2% by weight of at least one antioxidant additive relative to the total weight of the composition.

The lubricating composition of the invention may also comprise at least one detergent additive. Detergent additives generally allow a reduction in the formation of deposits on the surface of metal parts by dissolving secondary oxidation and combustion products.

The detergent additives that can be used in the lubricating composition of the invention may be anionic compounds comprising a long lipophilic hydrocarbon chain and hydrophilic head. The associated cation may be a metal cation of an alkaline or alkaline-earth metal. The detergent additives are preferably selected from among the salts of alkaline metals or alkaline-earth metals of carboxylic acids, sulfonates, salicylates, naphthenates, and phenate salts. The alkaline or alkaline-earth metals are preferably calcium, magnesium, sodium or barium. These metal salts generally comprise the metal in stoichiometric amount or in excess i.e. an amount greater than the stoichiometric amount. They are then overbased detergent additives; the excess metal imparting the overbased nature to the detergent additive is then generally in the form of an oil-insoluble metal salt e.g. a carbonate, hydroxide, an oxalate, acetate, glutamate, preferably a carbonate.

Advantageously, the lubricating composition of the invention may comprise 2 to 4% by weight of detergent additive relative to the total weight of the lubricating composition.

Also advantageously, the lubricating composition of the invention may also comprise at least one pour point depressant additive.

By slowing the formation of paraffin crystals, pour point depressants generally improve the behaviour of the lubricating composition of the invention under cold temperatures.

As examples of pour point depressant additives, mention can be made of alkyl polymethacrylates, polyacrylates, polyarylamides, polyalkylphenols, polyalkylnaphthalenes, alkylated polystyrenes.

Advantageously the lubricating composition of the invention may also comprise at least one dispersant. The dispersant can be selected from among Mannich bases, succinimides and derivatives thereof.

Also advantageously, the lubricating composition of the invention may comprise 0.2% to 10% by weight of dispersant relative to the total weight of the lubricating composition.

Advantageously, the lubricating composition may also comprise at least one additional polymer to improve the viscosity index. As examples of additional polymer to improve the viscosity index, mention can be made of polymer esters, homopolymers or copolymers, hydrogenated or non-hydrogenated, styrene, butadiene and isoprene, polymethacrylates (PMA).

Also advantageously, the lubricating composition of the invention may comprise 1 to 15% by weight of additional polymer improving the viscosity index relative to the total weight of the lubricating composition.

The lubricating composition of the invention can be prepared following method (A) comprising:
preparing a mixture comprising:
   a surfactant system comprising at least one non-ionic surfactant derivative of fatty alcohols, or a mixture or at least two non-ionic surfactant derivatives of fatty alcohols, or a condensate of at least two non-ionic surfactant derivatives of fatty alcohols, or any combination thereof, and
   a phase-change material;
adding this mixture to a base oil.

The lubricating composition of the invention can be prepared following method (B) comprising:
preparing a solution comprising:
   a surfactant system comprising at least one non-ionic surfactant derivative of fatty alcohols, or a mixture of at least two non-ionic surfactant derivatives of fatty alcohols, or a a condensate of at least two non-ionic surfactant derivatives of fatty alcohols or any combination thereof, and
   a phase-change material;
adding this solution to a base oil.

The lubricating composition of the invention can be prepared following method (C) comprising:
preparing a mixture comprising:
   a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof;
   a base oil;
adding this mixture to a phase-change material.

The lubricating composition of the invention can be prepared following method (D) comprising:
preparing a solution comprising:
   a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof; and
   a base oil;
adding this solution to a phase-change material.

Preferably, method (A) of the invention comprises:
preparing a mixture comprising:
   a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
   a phase-change material;
adding this mixture to a base oil.

Also preferably, method (B) of the invention comprises:
preparing a solution comprising:
   a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
   a phase-change material;
adding this solution to a base oil.

More preferably, method (C) of the invention comprises:
preparing a mixture comprising:
   a surfactant system comprising at least one non-ionic surfactant derivative of fatty alcohols, or a mixture of at least two non-ionic surfactant derivatives of fatty alcohols, or a condensate of at least two non-ionic surfactant derives of fatty alcohols, or any combination thereof, and
   a base oil;
adding this mixture to a phase-change material.

Also more preferably, method (D) of the invention comprises:
preparing a solution comprising:
   a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
   a base oil;
adding this solution to a phase-change material.

The lubricating composition of the invention is particularly advantageous for the lubrication of mechanical parts subjected to major heating, hence the use thereof for engine lubrication. It can especially be used to lubricate motor vehicle engines.

When in use, the lubricating composition of the invention is therefore placed in contact with at least one engine part.

Particularly advantageously, the use of the lubricating composition of the invention allows engine clogging to be reduced. It can also allow a reduction in the amount of coking products inside an engine.

This use of a lubricating composition of the invention is therefore of particular advantage to improve engine cleanliness, in particular to improve the cleanliness of the engine pistons.

The invention also concerns the use of a phase-change material as defined by the invention as thermal agent in an engine lubricating composition. The use of a phase-change material of the invention as thermal agent in a lubricating composition is also part of the invention.

The invention also concerns the use of a mixture or of a solution of a surfactant system as defined by the invention and of a phase-change material as defined by the invention, as thermal agent in an engine lubricating composition or as thermal agent in a lubricating composition defined by the invention.

The different aspects of the invention can be illustrated by the following examples.

### EXAMPLE 1: PREPARATION OF MONOPHASIC LUBRICATING COMPOSITIONS ACCORDING TO THE INVENTION COMPRISING A BASE OIL (1)

Three monophasic lubricating compositions of the invention were prepared following the method of the invention. At a first step, a solution was prepared by adding two surfactant compounds to a base oil. At a second step, this solution was mixed in water.

The surfactant compounds were known products. These were Emulsogen MTP070 (non-ionic emulsifier comprising a fatty alcohol of vegetable origin—produced by Clariant—having a viscosity measured at 25° C. as per standard EN ISO 2555 of 110 mPa·s, a cloud point measured as per standard DIN ISO 3015 of 11-13° C., a pour point measured as per standard DIN ISO 3016 of 6-8° C.), and Genapol O 020 (CAS 68920-66-1, C₁₆-C₁₈ saturated and C₁₈ unsaturated polyethoxylated oleic alcohol with 2-5 ethoxy repeating units—produced by Clariant—having a density measured at 50° C. as per standard DIN 51757 of 0.88 g/cm³, a dynamic viscosity measured at 50° C. as per standard DIN 53015 of 12 mPa·s, a pour point measured as per standard DIN ISO 3016 of 11.7° C.).

The base oil (1) was a Group IV PAO oil (product: Yubase 4+—by SK).

The compositions of the invention were prepared in the proportions (weight %) given in Table 1.

TABLE 1

| | Composition | Composition | Composition |
|---|---|---|---|
| | (1) | (2) | (3) |
| Base oil (1) | 94.8 | 93.4 | 94.1 |
| Genapol O 020 | 1.0 | 1.0 | 1.0 |
| Emulsogen | 4.0 | 3.9 | 4.0 |
| MTP 70 | | | |
| Distilled water | 0.2 | 1.7 | 0.9 |

The stability of the compositions of the invention was evaluated and allowed the demonstration that they are stable at ambient temperature and do not exhibit visually distinguishable separated phases

### EXAMPLE 2: PREPARATION OF MONOPHASIC LUBRICATING COMPOSITIONS OF THE INVENTION COMPRISING A BASE OIL (2) INCLUDING ADDITIVES

Two monophasic lubricating compositions of the invention were prepared in similar manner to the monophasic lubricating composition in Example 1, replacing the base oil (1) by a base oil (2) including additives.

The base oil (2) including additives comprised a Group III base oil (78% by weight—Group III refined base oil of KV100=4.3 mm²·s⁻¹—Nexbase 3043—produced by Neste), a Group III base oil (3.1 weight %—Group III refined base oil of KV100=5 mm²·s⁻¹—Nexbase 3050—produced by Neste), a VI improving polymer (Viscosity Index) of hydrogenated polyisoprene/styrene type (5.3 weight %—SV261—produced by Infineum), a polymer (0.3 weight %—PPD-polymethacrylate—Lubrizol 7748—produced by Lubrizol) and an additive package (13.3 weight %—salicylate dispersants, succinimide dispersants, zinc dithiophosphate anti-wear, alkylated diphenylamine antioxidant and sterically hindered phenols, polysiloxane defoamer—P6660—produced by Infineum).

The compositions of the invention were prepared in the proportions (weight %) given in Table 2.

TABLE 2

| | Composition (4) | Composition (5) |
|---|---|---|
| Base oil (2) | 93.4 | 94.1 |
| with additives | | |
| Genapol O 020 | 1.0 | 1.0 |
| Emulsogen | 3.9 | 4.0 |
| MTP 70 | | |
| Distilled water | 1.7 | 0.9 |

The stability of the compositions of the invention was evaluated and allowed the demonstration that they are stable at ambient temperature and that they do not exhibit visually distinguishable separated phases.

### EXAMPLE 3: PREPARATION OF MONOPHASIC LUBRICATING COMPOSITIONS OF THE INVENTION COMPRISING A BASE OIL (3) INCLUDING ADDITIVES

Three monophasic lubricating compositions of the invention were prepared in similar manner to the monophasic lubricating composition is Example 2, replacing base oil (2) including additives by a base oil (3) including additives.

The base oil (3) including additives comprised a Group IV base oil 37.5 weight %—polyalphaolefin with KV100=4 mm²·s⁻¹), a Group IV base oil (35 weight %—polyalphaolefin with KV100=6 mm²·s⁻¹), a Group V base oil (10 weight %—trimethylolpropane ester—Priolube 3970—produced by Croda), an anti-friction agent (1 weight %—Mo dithiocarbamate—Sakuralube 525—produced by Adeka), a polymer (0.3 weight %—PPD-polymethacrylate—Viscoplex 1-258—produced by Evonik) and an additive package (10 weight %—salicylate dispersants, succinimide dispersants, zinc dithiophosphate anti-wear, antioxidant: alkylated diphenylamine and sterically hindered phenols, defoaming agent: polysiloxane—P6660—produced by Infineum).

The compositions of the invention were prepared in the proportions (weight %) given in Table 3.

TABLE 3

| | Composition | Composition | Composition |
|---|---|---|---|
| | (6) | (7) | (8) |
| Base oil (3) | 94.1 | 93.7 | 93.6 |
| with additives | | | |
| Genapol O 020 | 1.0 | 1.0 | 1.0 |
| Emulsogen | 4.0 | 3.9 | 3.9 |
| MTP 70 | | | |
| Distilled water | 0.9 | 1.4 | 1.5 |

The stability of the compositions of the invention was evaluated and allowed the demonstration that they are stable at ambient temperature and that they do not exhibit visually distinguishable separated phases.

### COMPARATIVE EXAMPLE 1: PREPARATION OF LUBRICATING COMPOSITIONS COMPRISING A BASE OIL 1

A comparative composition 1 was prepared according to Example 1. This comparative composition did not comprise water.

It comprised a base oil 1 (95 weight %), Genapol O 020 (1.0 weight %) and Emulsogen MTP 70 (4.0 weight %).

This comparative composition was stable.

### EXAMPLE 4: EVALUATION OF THE THERMAL PERFORMANCE OF THE MONOPHASIC LUBRICATING COMPOSITIONS OF THE INVENTION

The heat-capacity rate of the monophasic lubricating compositions of the invention was measured by Differential Scanning Calorimetry—DSC) at different temperatures as per standard ASTM E1269. The latent heat of vaporization of the monophasic lubricating compositions of the invention was also evaluated by DSC under the following conditions:
weight of sample taken: 20 mg,
temperature ramp: 10° C. to 100° C. at 1° C./min,
atmosphere: nitrogen (20 mL/min).

The results are given in Table 4.

TABLE 4

| | Composition | Composition | Composition | Composition | Composition |
|---|---|---|---|---|---|
| | (2) | (3) | (4) | (5) | (6) |
| heat-capacity | | | | | |
| rate(J/g · K) | | | | | |
| at 20° C. | 1.66 | 1.78 | 1.59 | 2.09 | 2.08 |
| at 25° C. | 1.75 | 1.79 | 1.69 | 2.11 | 2.12 |
| at 30° C. | 1.83 | 1.80 | 1.77 | 2.12 | 2.14 |
| at 35° C. | 1.88 | 1.82 | 1.84 | 2.14 | 2.15 |
| at 40° C. | 1.93 | 1.84 | 1.89 | 2.16 | 2.17 |
| at 45° C. | 1.97 | 1.87 | 1.94 | 2.18 | 2.20 |
| at 50° C. | 2.00 | 1.90 | 1.98 | 2.22 | 2.23 |
| at 55° C. | 2.03 | 1.93 | 2.03 | 2.25 | 2.26 |
| at 60° C. | 2.05 | 1.96 | 2.08 | 2.28 | 2.30 |
| Latent heat | −4.838 | −6.651 | −5.085 | −9.82 | −10.51 |
| of | | | | | |
| vaporization | | | | | |
| (J/g) | | | | | |

The heat-capacity rate of the monophasic lubricating compositions of the invention is particularly advantageous. It increases as a function of temperature.

The latent heat of vaporization demonstrates the capability of the monophasic lubricating compositions of the invention to evacuate thermal energy when used to lubricate a motor vehicle engine.

1-13. (canceled)

14. A monophasic lubricating composition suitable for engine lubrication comprising:
a base oil,
a surfactant system comprising:
at least one non-ionic surfactant derivative of fatty alcohols, or
a mixture of at least two non-ionic surfactant derivatives of fatty alcohols, or
a condensate of at least two non-ionic surfactant derivatives of fatty alcohols, or
any combination thereof;
up to 5 weight % of a phase-change material.

15. The monophasic lubricating composition according to claim 14, wherein the surfactant system comprises at least one derivative of polyalkoxylated fatty alcohols comprising a saturated or unsaturated, straight-chain or branched C₁₂-C₆₀-alkyl group.

16. The monophasic lubricating composition according to claim 14, wherein the surfactant system comprises at least one derivative selected from among:
derivatives of polyalkoxylated fatty alcohols;
a fatty alcohol alkoxylate;
a fatty alcohol polyglycol ether;
a C₁₆-C₁₃ oleic alcohol derivative;
a C₁₆-C₁₃ oleic alcohol derivative comprising saturated C₁₆-C₁₃ groups, unsaturated C₁₃ groups and alkoxy groups;
a C₁₆-C₁₈ oleic alcohol derivative comprising saturated C₁₆-C₁₈ groups, unsaturated C₁₈ groups and 2 to 5 alkoxy groups.

17. The monophasic lubricating composition according to claim 14, wherein the surfactant system comprises a mixture of:
(a) a fatty alcohol alkoxylate; and
(b) a C₁₆-C₁₈ oleic alcohol derivative comprising saturated C₁₆-C₁₈ groups, unsaturated C₁₈ groups and 2 to 5 alkoxy groups.

18. The monophasic lubricating composition according to claim 14, wherein the phase-change material has a liquid-gas phase change.

19. The monophasic lubricating composition according to claim 14, wherein the phase-change material has an enthalpy of vaporization or latent heat of vaporization measured at 100° C. and under 0.101 MPa, ranging from 800 to 3 500 kJ/kg.

20. The monophasic lubricating composition according to claim 14, wherein the phase-change material has a boiling point at normal pressure ranging from 50 to 150° C.

21. The monophasic lubricating composition according to claim 14, wherein the phase-change material is selected from among carboxylic acids, ethers, alcohols, short-chain alcohols, C₁-C₈ alcohols, water.

22. The monophasic lubricating composition according to claim 21 wherein the phase-change material is water.

23. The monophasic lubricating composition according to claim 14, wherein the composition comprises up to 3 weight % of phase-change material.

24. The monophasic lubricating composition according to claim 14, wherein the composition is prepared following a method selected from among:
method (A) comprising:
preparing a mixture comprising:
a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
a phase-change material;
adding this mixture to a base oil;
method (B) comprising:
preparing a solution comprising:
a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
a phase-change material;
adding this solution to a base oil;
method (C) comprising:
preparing a mixture comprising:
a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof; and
a base oil;
adding this mixture to a phase-change material;
method (D) comprising:
preparing a solution comprising:
a surfactant system comprising at least one non-ionic surfactant derivative of fatty alcohols, or a mixture of at least two non-ionic surfactant derivatives of fatty alcohols, or a condensate of at least two non-ionic surfactant derivatives of fatty alcohols, or any combination thereof, and
a base oil;
adding this solution to a phase-change material.

25. A method for lubrication of a motor vehicle engine, comprising:
providing the monophasic lubricating composition of claim 14; and
applying the composition to surfaces of the motor vehicle engine.

26. A monophasic lubricating composition suitable for engine lubrication comprising:
a base oil,
a surfactant system; and
up to 5 weight % of a phase-change material;
wherein the surfactant system comprises a mixture of at least two non-ionic surfactant derivatives of a fatty alcohol selected from the group consisting of:
a derivative of polyalkoxylated fatty alcohols comprising a saturated or unsaturated, straight-chain or branched C₁₂-C₆₀-alkyl group;
derivatives of polyalkoxylated fatty alcohols;
a fatty alcohol alkoxylate;
a fatty alcohol polyglycol ether;
a C16-C18 oleic alcohol derivative;
a C16-C18 oleic alcohol derivative comprising saturated C16-C18 groups, unsaturated C18 groups and alkoxy groups; and
a C16-C18 oleic alcohol derivative comprising saturated C16-C18 groups, unsaturated C18 groups and 2 to 5 alkoxy groups.
